(19) United States
(12) Patent Application Publication
(10) Pub. No.: US 2024/0410687 A1
(43) Pub. Date: Dec. 12, 2024

(54) REFERENCE MASTER ASSEMBLY FOR CHECKING EQUIPMENT AND METHOD FOR SETTING UP THE REFERENCE MASTER ASSEMBLY

(71) Applicant: Marposs Societa' Per Azioni, Bentivoglio (BO) (IT)

(72) Inventor: Roberto BARUCHELLO, Baricella (BO) (IT)

(21) Appl. No.: 18/701,918

(22) PCT Filed: Nov. 8, 2022
(86) PCT No.: PCT/EP2022/081117

§ 371 Date: Apr. 16, 2024

(30) Foreign Application Priority Data
Nov. 9, 2021 (IT) 102021000028412

(51) Int. Cl. G01B 11/25; G01B 11/245

(52) U.S. Cl. CPC G01B 11/2504; G01B 11/245; G01B 11/2522

(57) ABSTRACT

A reference master assembly (7) for the calibration of a checking equipment for checking a mechanical part (1) which generates a three-dimensional numerical object corresponding to at least some portions of the mechanical part and includes optoelectronic sensors (2, 3) such as laser scanners that emits light planes on these portions of the mechanical part. The reference master assembly has a support body (8) and at least two trihedrons (T1, T2, T3), connected to it in mutually known positions, which define reference surfaces (4, 5, 6) on which the light planes are projected in the calibration phase. The trihedrons are connected to the support body with a pivoting coupling that allows the orientation of the reference surfaces to be adjusted in space. A method for setting the reference master assembly involves arranging the mechanical part to be checked in a checking position on a rotating support, orienting the optoelectronic sensors so that the light plane crosses the portions of interest of the mechanical part to be checked, arranging the reference master assembly in the checking position, adjusting the orientation of the trihedrons so that the light plane crosses the reference surfaces, and fixing the orientation of the trihedrons, before taking the reference master assembly to the metrology room for the certification of the configuration that is so defined.

### TECHNICAL FIELD

The present invention relates to a reference master assembly used for carrying out calibration operations of an equipment for checking a mechanical part which generates a three-dimensional numerical object starting from a physical object, more specifically a three-dimensional numerical object corresponding to the mechanical part to be checked, or to at least some portions of this mechanical part. The numerical object is then intended for per se known processing to carry out measurements relating to the mechanical part to be checked.

The invention also relates to a method for setting up the reference master assembly to calibrate the equipment for checking a mechanical part.

### BACKGROUND ART

Equipments are known comprising optoelectronic distance sensors, in particular 2D laser scanners, suitably arranged and oriented with respect to the mechanical part to be checked.

A calibration phase is needed for getting the proper arrangement and orientation of the sensors with reference to the specific mechanical part to be checked, and reference masters or reference master assemblies to be employed in the calibration phase are also known.

The known equipments are adapted to check mechanical parts having shapes and nominal dimensions different from one another, and such shapes may be complex. The corresponding reference master assemblies consequently need complex and/or costly and/or length set up operations.

### DISCLOSURE OF THE INVENTION

The object of the present invention is to provide a reference master assembly having a simple and not expensive structure and adapted to be simply and quickly set up for carrying out calibration operations on a checking equipment including at least an optoelectronic sensor.

It is also an object of the present invention to provide a simple and quick method for setting up such a reference master assembly.

The present invention provides a reference master assembly and a method for setting up such a reference master assembly as defined in the attached claims. The claims describe embodiments of the present invention and form an integral part of the present description.

### BRIEF DESCRIPTION OF THE DRAWINGS

The present invention is described with reference to the attached drawings, which illustrate non-limiting examples of embodiment, in which:

FIG. 1 schematically shows components of an equipment with two optoelectronic sensors, for checking a mechanical part;

FIG. 2 is a perspective view of a reference master assembly according to the present invention; and

FIG. 3 shows two perspective views, one of them being partially cross-sectioned, of a component of the reference master assembly of FIG. 2.

### BEST MODE FOR CARRYING OUT THE INVENTION

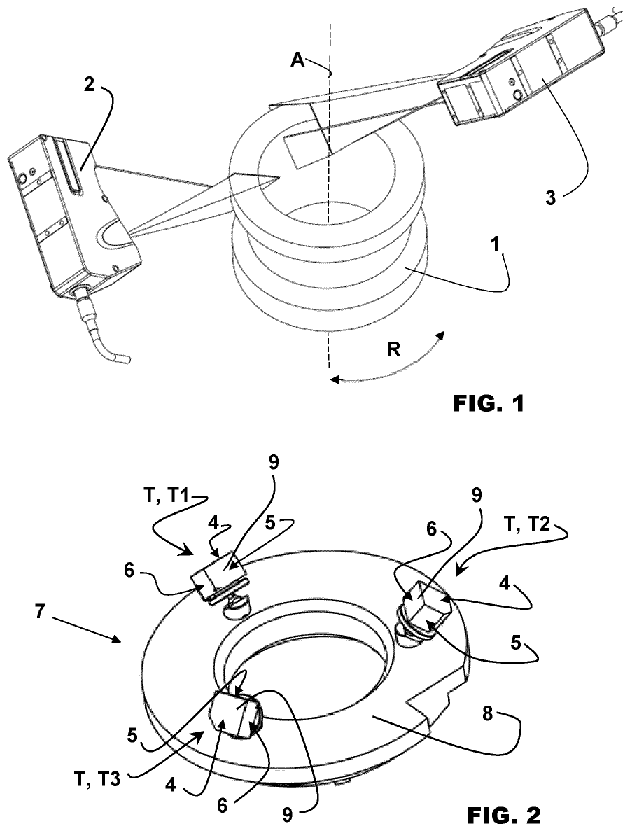

FIG. 1 schematically shows components of an equipment with two laser scanners 2 and 3, for checking a mechanical part 1, for example a multidiameter workpiece. Each of the laser scanners 2, 3 emits a light plane: when an object, more specifically the mechanical part 1, intercepts this light plane, a light line is generated at the intersection between the mechanical part 1 and the light plane.

The physical aspect of the mechanical part 1 to be checked, i.e. its shape and size, ‘shapes’ the light line that is generated.

The light line that is shaped in such a way by the mechanical part 1 is observed from an angled position by means of a 2D or matrix camera, which is part of the checking device (laser scanner 2, 3).

The shaped light line as seen by the checking device is digitized and interpreted as a succession of a plurality of points, for example in the order of some thousands.

The position of each point of the shaped light line in the light plane emitted by the laser scanner 2, 3 is detected and identified by means of a pair of X, Z coordinates.

Each laser scanner 2, 3 is stationary and the mechanical part 1 to be checked is rotating so that the portions on which checks/measurements are to be carried out are visible by the laser scanner 2, 3, i.e. they are illuminated and intercepted by the light plane(s) during rotation.

The output of the laser scanner 2, 3 is a numerical matrix including the X, Z pairs of coordinate values of the points of N light lines detected—one at each acquisition instant of the laser scanner 2, 3—during the rotation of the mechanical part 1, with respect to a fixed reference system.

This matrix can be interpreted as a plurality of two-dimensional clouds of points on many parallel planes placed side by side like the playing cards of a deck (the laser scanner 2, 3 does not know that it is a rotating object, because it does not have any data concerning the phase). The two-dimensional clouds of points are ordered one after the other, in the temporal order in which the corresponding light lines are detected.

The object obtained in this way appears to be a three-dimensional cloud of points but it is not; indeed it is a succession of two-dimensional clouds, that can be interpreted as a representation of the mechanical part 1 being both ‘unrolled’ along the scanning direction of the laser 2, 3 and distorted. As a general consideration in this regard, it should be noted that mechanical parts which, rotating under the laser light, have a trajectory that does not strike perpendicularly on the light plane of the laser light, appear distorted. In order to obtain the three-dimensional numerical object corresponding to the mechanical part 1 to be checked, on which the desired measurements can be carried out, it is therefore necessary to ‘re-roll’ the succession of two-dimensional clouds of points, simultaneously correcting the distortions.

To do this, it is necessary to associate a phase to each X, Z pair of coordinates identifying the points in the laser system, and then transform the two-dimensional clouds of points by means of (per se known) coordinate transformation algorithms into a proper three-dimensional cloud of points, in a machine reference system.

In order to know the phase of each X, Z pair of coordinates that identifies one of the points, it is necessary, among other things, to know the exact position of the axis of rotation A of the mechanical part 1 with respect to the reference system of the laser. The origin of the reference system of the laser scanners 2, 3 is generally not defined in any way by means of mechanical references, therefore it is not possible to obtain the desired positioning during the assembly phase.

A calibration phase and an appropriate reference master assembly are therefore required. Methods are known which make it possible to know the position of the origin of the reference system of a laser scanner with respect to a reference system associated with a reference master assembly, the latter including a portion defining reference surfaces that is a trihedron shaped portion. More specifically, the trihedron shaped portion features three mutually perpendicular plane faces that are crossed by the light plane emitted by the laser scanner.

In order to identify the exact position of the axis A of rotation of the reference master assembly with respect to the reference system of the laser scanner, a reference master assembly 7 according to the present invention comprises at least two trihedrons T in known mutual positions, for example fixed to a same support body or frame 8, and intended to rotate together with the support body or frame 8 and, during rotation, to be crossed one after the other by the light plane emitted by the laser scanner 2, 3.

According to a possible embodiment of the present invention (shown in FIG. 2), the reference master assembly comprises three trihedrons T1, T2, T3—more specifically three elements 9 each of which includes three plane reference surfaces 4, 5, 6 which are nominally and substantially perpendicular to one another defining one of the trihedrons T1, T2, T3—arranged in mutually known positions. It is pointed out that any of the trihedrons T1, T2, T3 can be defined by plane reference surfaces 4, 5, 6 which are not exactly perpendicular to one another, since this deviation with respect to the nominal shape can be easily compensated by the measuring software employed. The number of trihedrons T, suitably arranged, can be advantageously increased to four or more.

The mechanical part 1 to be checked is arranged in a checking position on a rotating table or rotating support, the latter being schematically represented in FIG. 1 with the reference R, and each laser scanner (one or more) 2, 3 is positioned and suitably inclined in such a way that the emitted light plane crosses, during the rotation, all the regions of interest of the mechanical part 1, that is all the portions of the mechanical part 1 that must be measured. Predicting ex-ante the position and arrangement of the laser scanner(s) 2, 3 would be very complex, and adjustments on site would most of the times be inevitably needed when the mechanical part 1 to be checked is placed in the checking position on the rotating support R. The position in space, or orientation, of the reference surfaces 4, 5 and 6, that is of the trihedrons T1, T2 and T3 of the reference master assembly 7, must adapt to the final position and orientation of the laser scanner(s) 2, 3 to ensure that, in at least one position during the rotation of the reference master assembly 7 the light plane(s) emitted by the laser scanner(s) 2, 3 simultaneously illuminate and cross all the three faces or mutually perpendicular reference surfaces 4, 5 and 6 that share a calibrated vertex, so generating a shaped or broken line consisting of three straight segments.

The definition of the position and orientation of the laser scanner(s) 2, 3 takes place at an advanced stage of the production of the checking equipment. Designing and manufacturing the reference master assembly 7 at this point, would cause long waits and severe delays.

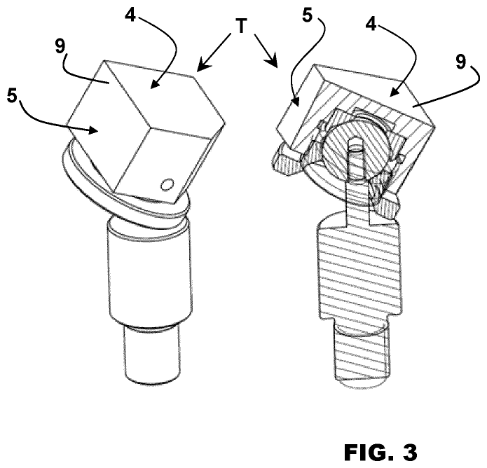

A reference master assembly 7 according to the invention-such as the one shown in FIG. 2—includes a support body or frame 8 to which trihedrons (for example three trihedrons) T1, T2 and T3 are connected in a pivoting way and their orientation can be adjusted in space as shown in the view and section of the FIG. 3. The orientation of each trihedron T is fixed (for example by gluing the corresponding element 9) once its position (which depends on the arrangement of the laser scanner(s) 2, 3) has been defined. Afterwards, the reference master assembly 7 is taken to the metrology room for the certification of the configuration that is so defined.

In such a way the reference master assembly 7 can be manufactured in advance and the post assembly operations can be limited just to fine-tuning movements of the pivoting coupling, fixation and subsequent certification. In summary: it is not required that the orientation of the trihedrons T, that is of the reference surfaces 4, 5 and 6, be known at the time of manufacturing of the reference master assembly 7. Such orientation can be defined and fixed when the configuration of the checking equipment, more specifically when the arrangement, in particular the inclination or orientation, of the laser scanner(s) 2, 3, is adapted, in operation, to the specific mechanical part 1 to be checked. As a consequence, a method according to the invention for setting up the reference master assembly 7 comprises the following steps: placing the mechanical part 1 to be checked in a checking position, typically on the rotating support R; orient each optoelectronic sensor present in the equipment (in the example of FIG. 1 each of the two laser scanners 2, 3) so that the relative light plane crosses the portions, or regions of interest of the mechanical part 1 to be checked; placing the reference master assembly 7 in the checking position; adjusting the orientation of the trihedrons T1, T2, T3 so that the light plane crosses the relative reference surfaces 4, 5 and 6, that is the three faces of the trihedrons T1, T2, T3; and fixing the orientation of the trihedrons T1, T2, T3. Afterwards, as already mentioned, the reference master assembly 7 is taken to the metrology room for the certification of the configuration that is so defined.

The number of pivoting trihedrons T of the reference master assembly 7 can vary according to the number of laser scanners 2, 3 that are employed, and is at least two, preferably three, if there is only one laser scanner 2. As a rule, an additional trihedron T is to be provided for each laser scanner 3 that is added to the first one. In the case of the equipment schematized in FIG. 1, the reference master assembly 7 preferably comprises four trihedrons T.

1. A reference master assembly for carrying out calibration operations of an equipment for checking a mechanical part, the equipment generating a three-dimensional numerical object corresponding to said mechanical part and comprising at least one optoelectronic sensor adapted to project a light plane on the mechanical part, the reference master assembly comprising:
a support body; and
at least two trihedrons defining reference surfaces and connected to the support body, the reference surfaces being adapted to be crossed by said light plane,
wherein each of said at least two trihedrons is connected to the support body via a pivoting coupling adapted to allow orienting the reference surfaces to be adjusted.

2. The reference master assembly according to claim 1, wherein the at least two trihedrons comprise at least three trihedrons connected to the support body.

3. The reference master assembly according to claim 2, wherein the at least two trihedrons comprise at least four trihedrons connected to the support body.

4. The reference master assembly according to claim 1, wherein the at least one optoelectronic sensor is comprises a laser scanner.

5. The reference master assembly according to claim 1, wherein the at least one optoelectronic sensor comprises two laser scanners, and wherein the at least two trihedrons comprises at least four trihedrons connected to the support body.

6. A method for setting up the reference master assembly according to claim 1, the method comprising:
placing the mechanical part in a checking position;
orienting said at least one optoelectronic sensor such that the light plane crosses portions of the mechanical part;
placing the reference master assembly in the checking position;
adjusting the orientation of the at least two trihedrons such that the light plane crosses the reference surfaces; and
fixing the orientation of the at least two trihedrons.

7. The method according to claim 6, further comprising, after fixing the orientation of the at least two trihedrons, taking the reference master assembly to a metrology room for certification of a configuration.

8. The method according to claim 6, wherein the mechanical part and the reference master assembly are arranged in the checking position on a rotating support.

9. The method according to claim 8, further comprising identifying a rotation axis of the mechanical part with respect to a reference system of the at least one optoelectronic sensor.
